(19) United States
(12) Patent Application Publication
(10) Pub. No.: US 2010/0232850 A1
(43) Pub. Date: Sep. 16, 2010

(54) Image forming unit and image forming apparatus

(75) Inventor: Kenji Koido, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 12/659,599

(22) Filed: Mar. 15, 2010

(30) Foreign Application Priority Data
Mar. 16, 2009 (JP) 2009-062911

(51) Int. Cl. G03G 21/10

(52) U.S. Cl. 399/357

(57) ABSTRACT

An image forming unit includes an image bearing body on which a latent image is formed, a charging member that charges the image bearing body, a developer bearing body that develops the latent image on the image bearing body using a developer so as to form a developer image, a transfer portion that transfers the developer image to a medium, a cleaning member that removes an adhering matter adhering to part of the image bearing body after the part of the image bearing body passes the transfer portion, a collection roller provided so as to form a contact portion between the collection roller and the image bearing body and is located between the cleaning member and the charging member, and a collection roller power source that applies a voltage to the collection roller. The voltage has the same polarity as a polarity of the developer.

### BACKGROUND OF THE INVENTION

The present invention relates to an image forming apparatus such as a copier, a facsimile machine or a printer, and also relates to an image forming unit used in the image forming apparatus.

It has been proposed to use a toner (i.e., a developer) containing toner mother particles added with relatively large external additives (with a mean particle diameter from 50 nm to 5000 nm) having a polarity opposite to the toner mother particles. See, for example, Japanese Laid-open Patent Publication No. 2003-295500 (FIG. 1). Use of such a toner contributes to preventing generation of fog on a medium, and enhancing image quality.

Recently, there is a demand for further enhancing the image quality.

### SUMMARY OF THE INVENTION

The present invention is intended to provide an image forming unit and an image forming apparatus capable of enhancing image quality.

The present invention provides an image forming unit including an image bearing body on which a latent image is formed, a charging member that electrically charges the image bearing body, a developer bearing body that develops the latent image on the image bearing body using a developer so as to form a developer image, a transfer portion that transfers the developer image to a medium, a cleaning member that removes an adhering matter that adheres to part of the image bearing body after the part of the image bearing body passes the transfer portion, a collection roller provided so as to form a contact portion between the collection roller and the image bearing body and is located between the cleaning member and the charging member, and a collection roller power source that applies to a voltage to the collection roller. The voltage applied to the collection roller has the same polarity as a polarity of the developer.

With such a configuration, it becomes possible to enhance the image quality.

Further scope of applicability of the present invention will become apparent from the detailed description given hereinafter. However, it should be understood that the detailed description and specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In the attached drawings:

FIG. 1 is a schematic view showing a configuration of an image forming apparatus according to the first embodiment of the present invention;

FIG. 2 is a sectional view showing a configuration of an image forming unit according to the first embodiment of the present invention;

FIG. 3 is a sectional view showing a main body of the image forming unit (with a developer storing body being detached therefrom) together with an LED head, a transfer roller and a transfer belt according to the first embodiment of the present invention;

FIG. 4 is a sectional view showing an internal structure of the developer storing body according to the first embodiment of the present invention;

FIG. 5 is a schematic view showing a shaker used to measure a charge amount of a toner;

FIG. 6 is a block diagram showing a main part of a control system of the image forming apparatus according to the first embodiment of the present invention;

FIG. 7A is a schematic view for illustrating a half-area solid image used in a printing test 1;

FIG. 7B is a schematic view for illustrating a whole-area halftone image used in the printing test 1;

FIG. 8 is a table showing experimental results of the printing test 1 according to the first embodiment of the present invention;

FIGS. 9A and 9B are schematic views for illustrating rotating directions of a collection roller and a photosensitive drum in a printing test 2;

FIG. 10 is a schematic view for illustrating a whole-area solid image used in the printing test 2, and

FIG. 11 is a table showing experimental results of the printing test 2 according to the second embodiment of the present invention.

### DETAILED DESCRIPTION OF THE PREFERRED EMBODIMENT

### First Embodiment

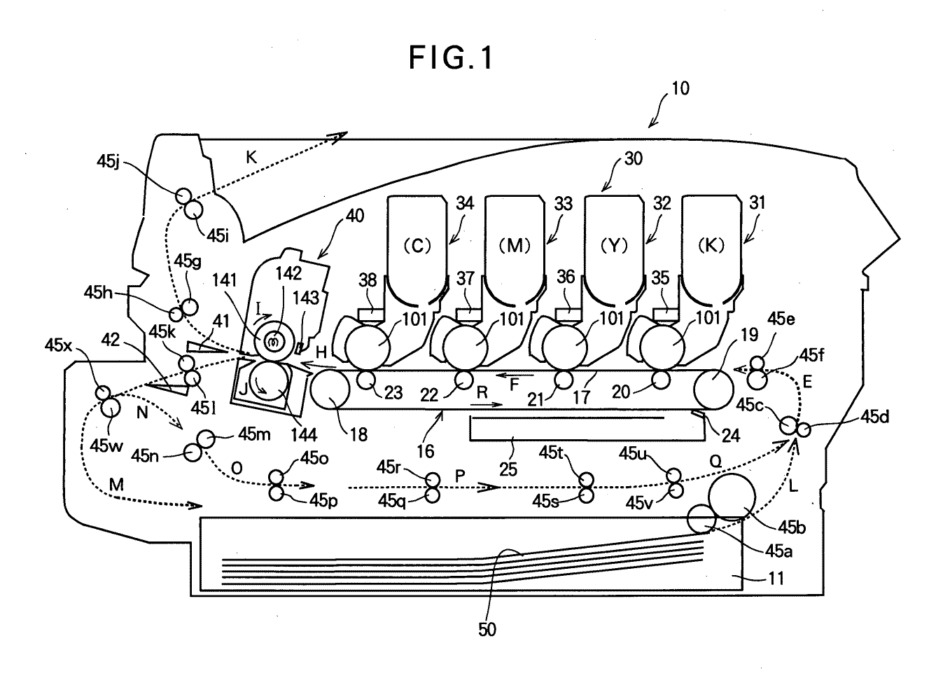

FIG. 1 is a schematic view showing an image forming apparatus 10 according to the first embodiment of the present invention.

In FIG. 1, the image forming apparatus 10 is configured as a color electrophotographic printer capable of forming images of Black (K), Yellow (Y), Magenta (M) and Cyan (C). The image forming apparatus 10 includes a sheet cassette 11 for storing a stack of recording sheets 50 (i.e., media), image forming units 31, 32, 33 and 34, a transferring portion 16, and a fixing portion 40. Feeding rollers 45a through 45x and feeding-path-switching guides 41 and 42 are provided for feeding the recording sheet 50 through the image forming units 31, 32, 33 and 34, the transferring portion 16 and the fixing portion 40.

In FIG. 1, sheet feeding paths in the image forming apparatus 10 are schematically shown by dashed arrows. The sheet cassette 11 storing the recording sheets 50 is detachably mounted to a lower part of the image forming apparatus 10. The feeding rollers 45a and 45b pick up the uppermost recording sheet 50 in the sheet cassette 11, and feed the recording sheet 50 in a direction shown by a dashed arrow L. The feeding rollers 45c and 45d and the feeding rollers 45e and 45f feed the recording sheet 50 toward the image forming portion 30 along the sheet feeding path in a direction shown by a dashed arrow E while correcting the skew of the recording sheet 50. In this regard, the feeding rollers 45a through 45f constitute a medium feeding portion.

Four detachable image forming units 31, 32, 33 and are linearly arranged along the sheet feeding path. The image forming units 31, 32, 33 and 34 have the same configurations except toners. LED (Light Emitting Diode) heads 35, 36, 37 and 38 as exposing devices are disposed corresponding to the image forming units 31, 32, 33 and 34. The image forming units 31, 32, 33 and 34, the LED heads 35, 36, 37 and 38 and the transfer portion 16 (described below) constitute an image forming portion 30.

The transfer portion 16 is configured to transfer toner images (i.e., developer images) formed by the image forming units 31, 32, 33 and 34 to an upper surface of the recording sheet 50 by means of Coulomb force as described later.

The transfer portion 16 includes a transfer belt 17 that electrostatically absorbs and feeds the recording sheet 50, a driving roller 18 rotated by a not shown driving unit to move the transfer belt 17, and a tensioning roller 19 that pairs with the driving roller 18 so that the transfer belt 17 is stretched around the driving roller 18 and the tensioning roller 19. The transfer portion 16 further includes transfer rollers 20, 21, 22 and 23 pressed against photosensitive drums 101 (described later) of the image forming units 31 through 34 via the transfer belt 17. The transfer rollers 20 through 23 are applied with voltages so as to transfer the toner images from the photosensitive drums 101 to the recording sheet 50. The transfer portion 16 further includes a transfer belt cleaning blade 24 that scrapes off the toner adhering to the transfer belt 17 and a waste developer tank 25 for storing the waste toner scraped off by the transfer belt cleaning blade 24.

Here, the configuration of the image forming unit 34 using the toner of cyan (C) will be descried. The configurations of the image forming units 31, 32 and 33 using the toners of black (K), yellow (Y) and magenta (M) are the same as the configuration of the image forming unit 34, and therefore descriptions thereof will be omitted.

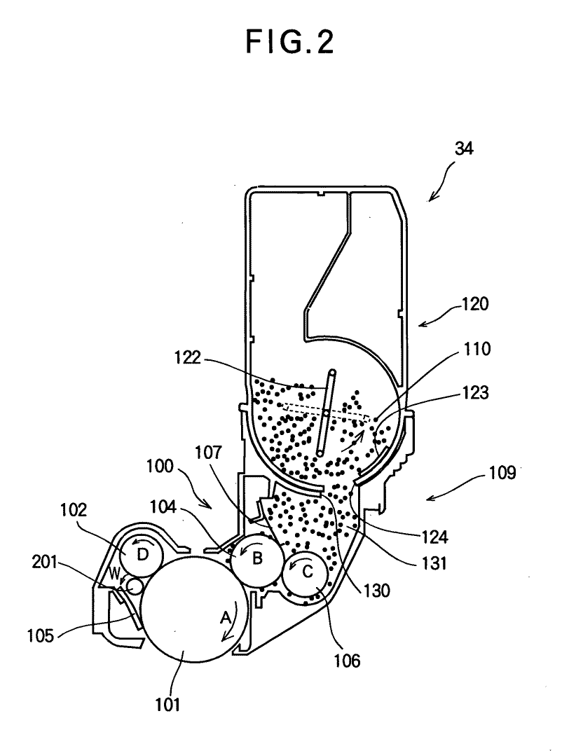

FIG. 2 is a sectional view schematically showing the configuration of the image forming unit 34. The image forming unit 34 includes a developing device 109. The developing device 109 includes a developing portion 100 including a developing roller 104, a supplying roller 106 and a developing blade 107. The developing device 109 further includes a developer storing body 120 in which a toner 110 (i.e., a developer) is stored. The image forming unit 34 further includes a photosensitive drum 101, a charging roller 102, a cleaning blade 105 and a collection roller 201. The image forming unit 34 is detachably mounted to the image forming portion 30 (FIG. 1). The developer storing body 120 is detachably mounted to the developing portion 100.

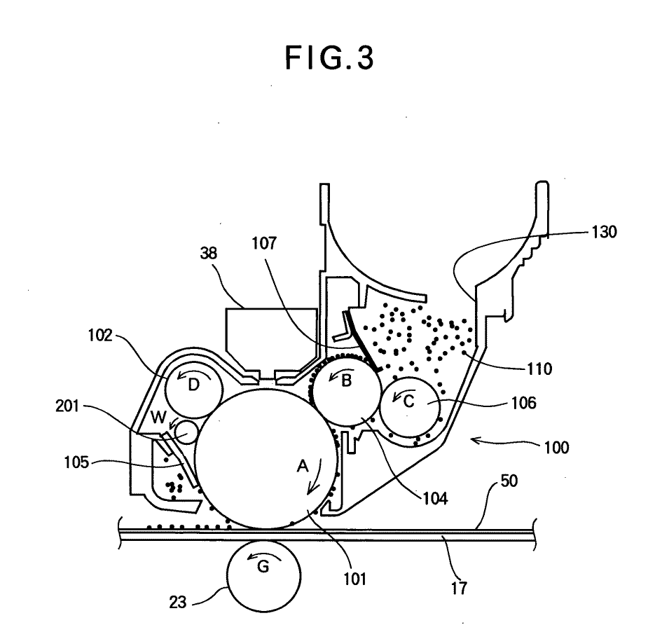

FIG. 3 is a sectional view schematically showing a main body of the image forming unit 34 (except the developer storing body 120) together with the LED head 35, the transfer roller 23 and the transfer belt 17. The photosensitive drum 101 as an image bearing body is an organic photosensitive body composed of, for example, a conductive supporting body and a photoconductive layer. To be more specific, the photosensitive drum 101 includes a metal pipe of aluminum as the conductive supporting body on which an electron generation layer and an electron transporting layer are layered as the photoconductive layer. The charging roller 102 as a charging member is provided contacting the circumferential surface of the photosensitive drum 101, and is composed of a metal shaft with a semiconductive epichlorohydrin rubber layer. The LED head 35 as an exposure device includes, for example, LED elements and a lens array, and is located so that lights emitted by the LED elements are focused on the surface of the photosensitive drum 101.

The developing roller 104 as a developer bearing body is provided contacting the circumferential surface of the photosensitive drum 101, and is composed of, for example, a metal shaft with a semiconductive urethane rubber layer. The supplying roller 106 as a supplying member is provided contacting the surface of the developing roller 104, and is composed of, for example, a metal shaft with a foaming semiconductive silicone sponge layer. The developing blade 107 as a layer regulating member is pressed against the surface of the developing roller 104, and is composed of, for example, a stainless steel. The cleaning blade 105 as a cleaning member is pressed against the photosensitive drum 101, and is composed of, for example, a urethane rubber. The collection roller 201 as a collection member is provided contacting the circumferential surface of the photosensitive drum 101, and is composed of, for example, a metal shaft with a semiconductive epichlorohydrin rubber layer.

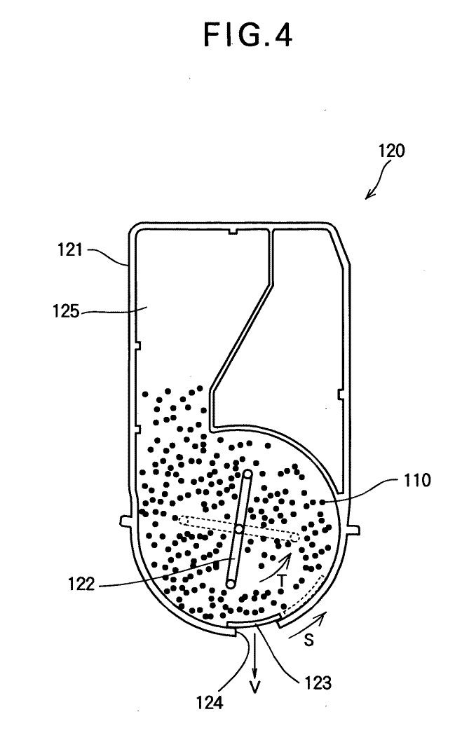

FIG. 4 is a sectional view showing an inner configuration of the developer storing body 120. The developer storing body 120 includes a container 121 that defines a developer storing portion 125. An agitation bar 122 is rotatably provided in the developer storing portion 125 and extends in a longitudinal direction of the container 121. Below the agitation bar 125, an outlet opening 124 is formed on the container 121 through which the toner 110 is ejected. A shutter 123 is provided inside the container 121, and is slidable as shown by an arrow S so as to open and close the outlet opening 124.

In FIG. 1, the recording sheet 50 to which the toner images of the respective colors are transferred by the image forming portion 30 (FIG. 1) is fed along the sheet feeding path in a direction shown by a dashed arrow H and reaches the fixing portion 40. The fixing portion 40 includes a heating roller 141, a pressure roller 144, a thermistor 143 and a heater 142. The heating roller 141 is composed of a cylindrical (hollow) metal core made of aluminum, a heat-resistant resilient layer made of silicone rubber covering the metal core, and a PFA (tetra-fluoroethylene-perfluoro-alkylvinyl-ether-copolymer) tube covering the resilient layer. The heater 142 such as a halogen lamp is provided inside the metal core of the heating roller 141.

The pressure roller 144 is composed of a metal core made of aluminum, a heat-resistance resilient layer made of silicone rubber covering the metal core, and a PFA tube covering the resilient layer. The pressure roller 144 and the heating roller 141 form a nip portion therebetween. The thermistor 143 is a detecting unit for detecting a surface temperature of the heating roller 141, and is provided in the vicinity of the heating roller 141 in a non-contact manner. Temperature information is sent by the thermistor 143 to a not shown temperature control unit. The temperature control unit controls ON/OFF of the heater 142 based on the temperature information to thereby maintain the surface temperature of the heating roller 141.

Constituent materials of the respective members will be further described. The cleaning blade 105 (FIG. 2) and the transfer belt cleaning blade 24 (FIG. 1) are made of resilient bodies such as, for example, urethane rubber, epoxy rubber, acrylic rubber, fluororesin rubber, nitrile butadiene rubber (NBR), styrene butadiene rubber (SBR), isoprene rubber (IR) or poly-butadiene rubber.

The photosensitive drum 101 can be, for example, an inorganic photosensitive drum and an organic photosensitive drum. The inorganic photosensitive drum is composed of a conductive supporting roller made of aluminum or the like covered with a photosensitive layer such as selenium or amorphous silicon. The organic photosensitive drum is composed of a conductive supporting roller made of aluminum or the like covered with an organic photosensitive layer made by dispersing electron generation agent and electron transporting agent in a binder resin.

The developing roller 104 can be composed of a conductive supporting shaft made of stainless steel covered with a layer of silicone rubber, urethane rubber or the like added with carbon for adjusting electric conductivity, as used in a general developing roller. The developing blade 107 (FIG. 2) can be made of material such as metal (for example, stainless steel) or rubber (for example, silicone rubber), as used in a general developing blade. The developing blade 107 can be applied with a voltage as necessary.

The toner 110 used in this embodiment will be described. The toner 110 is composed of toner mother particles containing at least binder resin added with external additives such as inorganic fine powder or organic fine powder. The toner 110 is stored in the developer storing body 120. Although the binder resin is not limited, it is preferable to use polyester resin, styrene-acrylic resin, epoxy resin, or styrene-butadiene resin. Further, releasing agent, coloring agent or the like can be added to the binder resin. Furthermore, other additives such as charge controlling agent, conductivity adjusting agent, fluidity enhancing agent or cleaning properties enhancing agent can be added to the binder resin as necessary.

The releasing agent is not limited, but it is preferable to use fatty series carbohydrate wax such as low molecular polyethylene, low molecular polypropylene, olefin copolymer, micro crystalline wax, paraffin wax or Fischer-Tropsch wax, oxide of fatty series carbohydrate wax such as polyethylene oxide wax, block copolymer of these materials, fatty series ester-based wax such as carnauba wax and montanic acid ester wax, or fatty series ester which is partially or entirely deoxidized such as deoxidized carnauba wax. It is preferable that 0.1 to 20 weight parts (more preferably 0.5 to 12 weight parts) of the releasing agent is added to 100 weight parts of the binder resin. It is also preferable to use a combination of a plurality of kinds of waxes.

The coloring agent is not limited, but it is preferable to use pigment or dye generally used in black, yellow, magenta and cyan toner, such as carbon black, iron oxide, phthalocyanine blue, permanent brown FG, brilliant fast scarlet, pigment green B, rhodamine B base, solvent red 49, solvent red 146, pigment blue 15:3, solvent blue 35, quinacridone, carmine 6B, disazo yellow and the like. It is preferable that 2 to 25 weight parts (more preferably, 2 to 15 weight parts) of the coloring agent is added to 100 weight parts of the binder resin.

Further, conventional charge controlling agent can be used. For example, quaternary ammonium salt charge control agent can be used for a positively chargeable toner, and azo complex charge control agent, salicylic acid charge control agent or calixarene charge control agent can be used for a negatively chargeable toner. It is preferable that 0.05 to 15 weight parts (more preferably, 0.1 to 10 weight parts) of the charge controlling agent is added to 100 weight parts of the binder resin.

The external additives are added for the purpose of enhancing environmental stability, charge stability, developing performance, fluidity and preserving property. It is preferable that 0.01 to 10 weight parts (more preferably 0.05 to 8 weight parts) of the external additives are added to 100 weight parts of the binder resin.

Next, a manufacturing method of the toner will be described.

First, the following materials were mixed in a Henschel mixer: 100 weight parts of binder resin (polyester resin, number average molecular weight Mn=3700, glass transition temperature Tg=62° C., softening temperature T_{1/2}=115° C.), 0.5 weight parts of charge control agent “BONTRON E-84” (manufactured by Orient Chemical Industry Co., Ltd.), 5.0 weight parts of pigment blue 15:3 (“ECB-301” manufactured by DainichiSeika manufacturing Co., Ltd.) as coloring agent, and 4.0 weight parts of carnauba wax (“Powdered Carnauba Wax No. 1” manufactured by S. Kato and Co.) as releasing agent. The resultant material was molten and kneaded using a twin-screw extruder. The resultant material was cooled, and cracked using a cutter mill whose screen size was 2 mm. Then, the resultant material was crushed using a crusher with an impact plate (“Dispersion Separator” manufactured by Nippon Pneumatic Manufacturing Co., Ltd.). Further, the resultant material was classified using an air classifier, so that toner mother particles “A” having a mean particle diameter of 6 μm were obtained. Next, the following external additives were added to 1 kg (100 weight parts) of the toner mother particles A: 3.0 weight parts of hydrophobic silica R972 (manufactured by Nippon Aerosil Ltd.) having a mean particle diameter of 16 nm, and 0.3 weight parts of melamine resin particles “EPOSTAR-S” (manufactured by Nippon Shokubai Co., Ltd.) having a mean particle diameter of 0.2 μm and having a charge amount of +212 μC/g. With such processes, the toner was obtained.

In this embodiment, the toner of cyan (C) with a charge amount of −26 μC/g was obtained. Further, the toner of black (B) with a charge amount of −27 μC/g, the toner of yellow (Y) with a charge amount of −31 μC/g, and the toner of magenta (M) with a charge amount of −25 μC/g were respectively obtained.

In this embodiment, the toner mother particles are negatively chargeable, and the melamine resin particles (as external additives) which are positively chargeable are added to the toner mother particles.

In this regard, measurement of the charge amount of the toner was performed as follows:

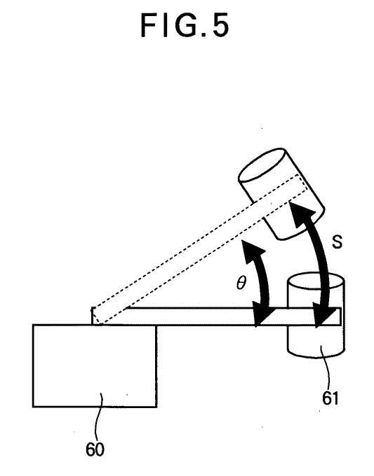

The toner and a carrier (to be more specific, a ferrite carrier “F-60” manufactured by Powder-Tech Co., Ltd.) were mixed at a ratio of 1:19 under a measurement environment with a temperature of 25° C. and a relative humidity of 50% using a shaker 60 named “YS-LD” (manufactured by Yayoi Co., Ltd.) as shown in FIG. 5. The shaker 60 had a holder (bottle) 61 in which the mixture of the toner and the carrier was held, and the shaker 60 shakes the bottle 61 at a shaking angle θ from 0 to 45°, at a shaking frequency of 200 strokes/minute, and at a stroke S of 80 mm.

Then, the mixture of the toner and the carrier was set in a powder charge measurement system “TB-203” manufactured by Kyocera Chemical Corporation equipped with a mesh (No. 400). The charge amount of the toner was measured under blow pressure of 7.0 Kpa for 10 seconds, and the average charge amount taken over the last 2 seconds is determined as the charge amount of the toner.

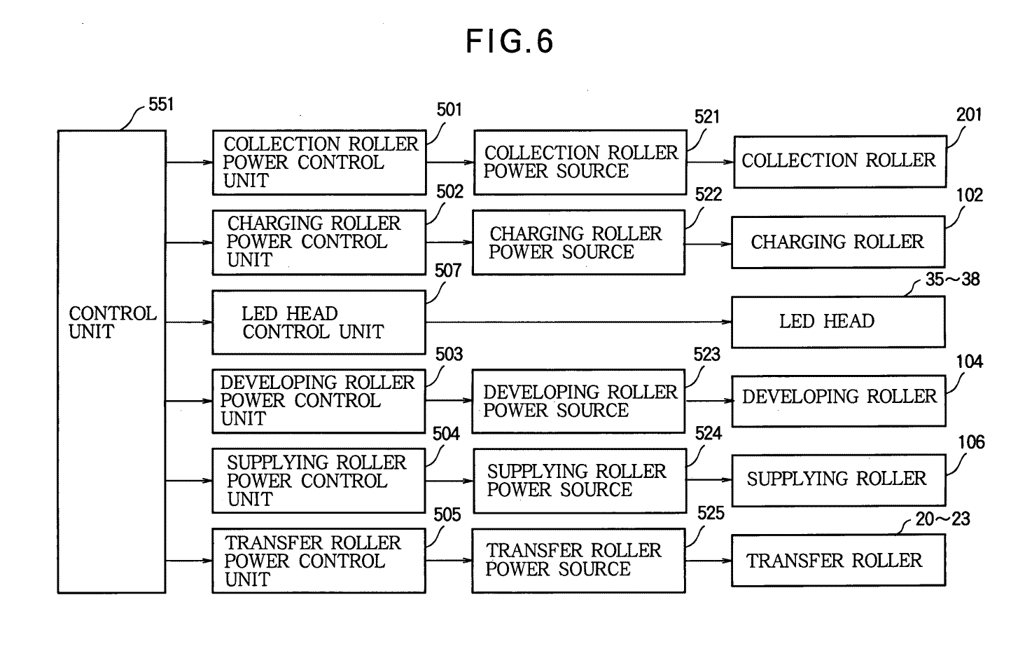

FIG. 6 is a block diagram showing a main part of a control system of the image forming apparatus 10. The control system of the image forming apparatus 10 will be described with reference to FIGS. 1, 2 and 6.

A control unit 551 includes a not shown micro processor, ROM, RAM, I/O port, timer and the like. The control unit 551 receives printing data and control command from a not shown superior device, and control a sequence of the printing operation of the image forming apparatus 10.

A collection roller power control unit 501 (i.e., a collection member power control unit) controls a voltage applied to the collection roller 201 according to instruction from the control unit 551 so as to charge the surface of the collection roller 201. In this regard, collection roller power control units are provided respectively for controlling the voltages applied to the collection rollers 201 of the image forming units 31, 32, 33 and 34, and these collection roller power control units are collectively described as the collection roller power control unit 501.

A charging roller power control unit 502 (i.e., a charging member power control unit) controls a voltage applied to the charging roller 102 according to instruction from the control unit 551 so as to charge the surface of the photosensitive drum 101 (FIG. 2). In this regard, charging roller power control units are respectively provided for controlling the voltages applied to the charging rollers 102 of the image forming units 31, 32, 33 and 34, and these charging roller power control units are collectively described as the charging roller power control unit 502.

An LED head control unit 507 (i.e., an exposure control unit) controls each of the LED heads 35, 36, 37 and 38 according to instruction from the control unit 551 so as to expose the surface of the photosensitive drum 101 (FIG. 2) with light to thereby form a latent image thereon. In this regard, LED head control units are respectively provided for controlling the LED heads 35, 36, 37 and 38, and these LED head control units are collectively described as the LED head control unit 507.

A developing roller power control unit 503 (i.e., a developer bearing body power control unit) controls a voltage applied to the developing roller 104 according to instruction from the control unit 551 so as to develop the latent image on the photosensitive drum 101 (FIG. 2). In this regard, developing roller power control units are respectively provided for controlling the voltages applied to the developing rollers 104 of the image forming units 31, 32, 33 and 34, and these developing roller power control units are collectively described as the developing roller power control unit 503.

A supplying roller power control unit 504 (i.e., a supplying member power control unit) controls a voltage applied to the supplying roller 106 according to instruction from the control unit 551 so as to supply the toner to the developing roller 101. In this regard, supplying roller power control units are respectively provided for controlling the voltages applied to the supplying rollers 106 of the respective image forming units 31, 32, 33 and 34, and these supplying roller power control units are collectively described as the supplying roller power control unit 504.

A transfer roller power control unit 505 (i.e., a transfer power control unit) controls a voltage applied to each of the transfer rollers 20, 21, 22 and 23 according to instruction from the control unit 551 so as to transfer the toner image from the surface of the photosensitive drum 1 to the recording sheet 50 (FIG. 1). In this regard, transfer roller power control units are respectively provided for controlling the voltages applied to the transfer rollers 20, 21, 22 and 23, and these transfer roller power control units are collectively described as the transfer roller power control unit 505.

A collection roller power source 521 (i.e., a collection member power source) applies a direct voltage to the collection roller 201 under the control of the collection roller power control unit 501. A charging roller power source 522 (i.e., a charging member power source) applies a direct voltage to the charging roller 102 under the control of the charging roller power control unit 502. A developing roller power source 523 (i.e., a developer bearing body power source) applies a direct voltage to the developing roller 104 under the control of the developing roller power control unit 503 so as to form the toner image by developing the latent image (formed by each LED head) with the toner. A supplying roller power source 524 (i.e., a supplying member power source) applies a direct voltage to the supplying roller 106 under the control of the supplying roller power control unit 504. A transfer roller power source 525 (i.e., a transfer power source) applies a direct voltage to the transfer roller under the control of the transfer roller power control unit 505 so as to transfer the toner image (developed by each developing roller 104) to the recording sheet 50.

Next, an operation of the image forming apparatus 10 will be described with reference FIGS. 1 through 6. Regarding the operations of the image forming units 31 through 34, the operation of the image forming unit 34 of cyan (C) (shown in FIGS. 2 through 4) will be described as a representative example.

As shown in FIG. 3, the photosensitive drum 101 is driven by a not shown driving unit to rotate at a constant circumferential speed in a direction shown by an arrow. A. The charging roller 102 rotates in a direction shown by an arrow D while contacting the surface of the photosensitive drum 101, and applies a direct voltage of, for example, −1140V (applied by the charging roller power source 522 shown in FIG. 6) to the surface of the photosensitive drum 101. The surface of the photosensitive drum 101 is uniformly charged at a voltage of, for example, −640V. Then, the LED head 35 facing the photosensitive drum 101 exposes the uniformly charged surface of the photosensitive drum 101 according to the image signal. The exposed part of the surface of the photosensitive drum 101 optically attenuates, and a latent image is formed thereon.

The shutter 123 of the developer storing body 120 is slid in the direction to open the outlet opening 124 as shown by the arrow S in FIG. 4 by operation of a not shown lever, after the developer storing body 120 is mounted to the developing portion 100 as shown in FIG. 2. The toner 110 in the container 121 of the developer storing body 120 falls via the outlet opening 124 in the direction shown by an arrow V (FIG. 4). As shown in FIG. 2, the toner 110 is supplied to a toner storing portion 131 of the developing portion 100 via a toner receiving opening 130 formed on an upper part of the image forming unit 34. The toner 110 fallen into the developing portion 100 is supplied to the developing roller 104 by means of the supplying roller 106 applied with the direct voltage (for example, −210V) by the supplying roller power source 524 (FIG. 6).

As shown in FIG. 3, the developing roller 104 is provided contacting the photosensitive drum 101, and is applied with the direct voltage (for example, −110V) by the developing roller power source 523 (FIG. 6). The developing roller 104 holds the toner 110 supplied by the supplying roller 106, and rotates to carry the toner 110 in a direction shown by an arrow B. In this process, the developing blade 107 (pressed against the developing roller 104 at a downstream side of the supplying roller 106) forms a layer of the toner 110 having a uniform thickness on the developing roller 104. The toner 110 on the developing roller 104 is normally charged to, for example, approximately −50V due to friction caused by a sliding contact between the developing roller 104 and the supplying roller 106 and by pressing of the developing blade 107 against the developing roller 104.

The developing roller 104 reversely develops the latent image formed on the photosensitive drum 101 using the toner 110. A bias voltage is applied between the photosensitive drum 101 and the developing roller 104 by the high voltage power source, and therefore lines of electrical force are generated due to the latent image formed on the photosensitive drum 101. Therefore, the charged toner 110 on the developing roller 104 moves to the latent image on the photosensitive drum 101 by the electrostatic force, so as to develop the latent image and form the toner image. This developing process (beginning with rotation of the photosensitive drum 101) is started at a predetermined timing described later.

As shown in FIG. 1, the recording sheet 50 stored in the sheet cassette 11 is fed one by one out of the sheet cassette 11 by the feeding rollers 45a and 45b in the direction shown by the dashed arrow L in FIG. 1. Then, the recording sheet 50 is fed by the feeding rollers 45c and 45d and the feeding rollers 45e and 45f along a not shown medium guide in the direction shown by the dashed arrow E while the skew of the recording sheet 50 is corrected. The recording sheet 50 reaches the image forming portion 30 where the recording sheet 50 is further fed by the transfer belt 17 that moves in the direction shown by a dashed arrow F by the rotation of the driving roller 18. In this regard, the above described developing process starts in the image forming unit 31, 32, 33 and 34 at predetermined timings while the recording sheet 50 is being fed in the direction shown by the dashed arrow E.

For example, in the image forming unit 34, the transfer roller 23 is disposed facing and pressed against the photosensitive drum 101 of the image forming unit 34 of cyan (C) via the transfer belt 17 as shown in FIG. 3, and is applied with the direct voltage (for example, +3000V) by the transfer roller high voltage power source 525 (FIG. 6). The transfer roller 23 transfers the toner image of cyan (C) from the photosensitive drum 101 to the recording sheet 50 which is electrostatically absorbed and fed by the transfer belt 17. This process is referred to as a transfer process.

As the recording sheet 50 is fed by the transfer belt 17 in the direction shown by the dashed arrow F in FIG. 1, the toner image of black (K) is transferred to the recording sheet 50 by the image forming unit 31 and the transfer roller 20, the toner image of yellow (Y) is transferred to the recording sheet 50 by the image forming unit 32 and the transfer roller 21, and the toner image of magenta (M) is transferred to the recording sheet 50 by the image forming unit 33 and the transfer roller 22 using the same developing process and the transfer process as those performed by the image forming unit 34 and the transfer roller 23.

The recording sheet 50 with the transferred toner image is fed in the direction shown by the dashed arrow H in FIG. 1, and reaches the fixing portion 40, where the recording sheet 50 is fed between the heat roller 141 and the pressure roller 144. The heat roller 141 rotates in a direction shown by an arrow I in FIG. 1, and the temperature of the heat roller 141 is controlled by the not shown temperature control unit to a predetermined temperature. The pressure roller 144 rotates in a direction shown by an arrow J. The heat roller 141 applies heat to the toner image to cause the toner image to be molten. The heat roller 141 and the pressure roller 144 apply pressure to the molten toner image so as to fix the toner image to the recording sheet 50.

The recording sheet 50 with the fixed toner image is fed in a direction shown by an arrow K by the feeding rollers 45g and 45h and the feeding rollers 45i and 45j (i.e., a medium ejecting portion), and is ejected out of the printer 10.

In this printing operation, there are cases where a slight amount of the toner 110 may remain on the surface of the photosensitive drum 101 after the transfer process. Such a residual toner 110 is removed by the cleaning blade 105. As shown in FIG. 3, the cleaning blade 105 is disposed parallel to a rotation axis of the photosensitive drum 101. A root portion of the cleaning blade 105 is fixed to a rigid supporting plate so that a tip of the cleaning blade 105 contacts the surface of the photosensitive drum 101. The residual toner 110 on the surface of the photosensitive drum 101 is removed by the cleaning blade 105 when the photosensitive drum 101 rotates about the rotation axis in a state where the cleaning blade 105 contacts the surface of the photosensitive drum 101. The photosensitive drum 101 from which the residual developer 101 is removed is repeatedly used.

Further, there are cases where the external additives of the toner 100 may not been removed by the cleaning blade 105, and may remain on the surface of the photosensitive drum 101 at a downstream side of a contact portion between the photosensitive drum 101 and the cleaning blade 105 in the rotating direction of the photosensitive drum 101. Such external additives are collected by the collection roller 201. The collection roller 201 rotates in a direction shown by an arrow W in FIG. 3, and is applied with the predetermined voltage by the collection roller power source 521 (FIG. 6). Detailed description of the collection roller 201 will be made later.

During a continuous printing operation, there is an interval after the printing is performed on one recording sheet 50 and before the printing is performed on the next recording sheet 50. In such an interval, part of insufficiently-charged toner 110 may be transferred to the transfer belt 17 from the photosensitive drums 101 of the image forming units 31, 32, 33 and 34. Such an insufficiently-charged toner 110 is removed from the transfer belt 17 by the transfer belt cleaning blade 24 and is stored in the waste developer tank 25 when the transfer belt 17 rotates in the direction shown by arrows F and R in FIG. 1. The transfer belt 17 from which the toner 110 is removed is repeatedly used.

In the case where a double-sided printing mode is selected, the recording sheet 50 with the fixed toner image is fed in a direction shown by a dashed arrow M by the feeding path switching guide 41, the feeding rollers 45k and 45l and the feeding rollers 45w and 45x, and then the recording sheet 50 is fed in a direction shown by a dashed arrow N by the feeding path switching guide 42 and the feeding rollers 45w and 45x, so that the recording sheet 50 is inverted. Then, the recording sheet 50 is fed in a direction shown by dashed arrows O, P and Q by the feeding rollers 45m, 45n, 45o, 45p, 45q, 45r, 45s, 45t, 45u and 45v. Then, the recording sheet 50 is fed in the direction shown by the dashed arrow E by the feeding rollers 45c and 45d, and the printing is performed on a backside of the recording sheet 50 (i.e., opposite to a side to which the toner image has been fixed).

Next, description will be made of a printing test 1 to examine an ability of the collection roller 201 to collect the external additives (i.e., adhering matter) that adheres to the photosensitive drum 101. In the printing test 1, a plurality of collection rollers 201 having different surface roughness Rz (μm) were prepared, and were applied with different voltages.

### Printing Test 1.

The printing test 1 was performed under the following conditions:

(1) In the printing test 1, the image forming apparatus 10 with the collection roller 201 was used, and a monochrome image was printed using the toner of cyan (C).

(2) The printing was performed under a room environment with a temperature of 25° C. and a humidity of 50%.

(3) A printing speed (equal to the circumferential speed of the photosensitive drum 101, and the sheet feeding speed) was set to 274 mm/s. The photosensitive drum 101 (30 mm in outer diameter), the charging roller 102 (11 mm in outer diameter), the collection roller 201 (11 mm in outer diameter), the developing roller 104 (16 mm in outer diameter) and the supplying roller 106 (13 mm in outer diameter) are rotated in directions respectively shown by arrows in FIG. 3. Further, the ratio of the circumferential speeds of the photosensitive drum 101, the charging roller 102, the collection roller 201, the developing roller 104 and the supplying roller 106 was set to 1:1:1:1.3:(1.3×0.6).

(4) Direct voltages of −1140V, −110V, −210V and +3000V are applied to metal shafts of the charging roller 102, the developing roller 104, the supplying roller 106 and the transfer roller 20 to 23.

(5) Surface potentials VA1 and VA2 of an exposed part and a non-exposed part of the surface of the photosensitive drum 101 were set as follows: VA1=+40V, VA2=−210V. Further, a surface potential Vd of the photosensitive drum 101 in an interval between printings (i.e., after the printing is performed on one recording sheet 50 before the printing is performed on the next recording sheet 50) was set to −80V.

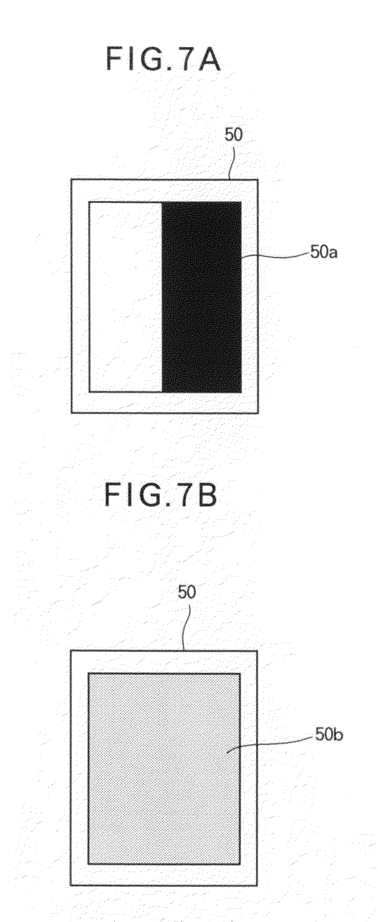

These surface potentials were measured as follows: A standard paper of A4 size (to be more specific, “Oki Excellent White Paper” having the basis weight of 80 g/m²) was used as the recording sheet 50. The recording sheet 50 was longitudinally fed (so that shorter edges of the recording sheet 50 became a leading end and a trailing end) so as to leave 60 mm between a trailing end of the preceding recording sheet 50 and a leading end of the next recording sheet 50. Further, a half-area solid image shown in FIG. 7A was continuously printed on ten pages. The half-area solid image of FIG. 7A had a solid image portion 50a printed at a printing density of 100% on a half-area (whose area ratio was 50%) of a whole-area (whose area ratio was 100%) of the recording sheet 50 except margin areas of 5 mm from four edges of the recording sheet 50. In the axial direction of the photosensitive drum 101, a half part of the surface of the photosensitive drum 101 corresponding to the solid image portion 50a is referred to as “A1 part” which corresponds to an exposed part exposed by the LED head 38. A remaining half part of the surface of the photosensitive drum 101 is referred to as “A2 part” corresponding to a non-exposed part. The surface potentials of the A1 part and the A2 part were measured by setting probes “MODEL 555P-4” (manufactured by Trek Incorporated) of a surface potential meter “MODEL 344” (manufactured by Trek Incorporated). As a result of measurement, the surface potential of the A1 part was +40V after the transferring of the toner image to the recording sheet 50 during printing, and was −80V in the interval between printings. Further, the surface potential of the A2 part was −210V after the transferring of the toner image to the recording sheet 50 during printing, and was −80V in the interval between printings.

(6) Nine kinds of the collection rollers 201 having the surface roughness Rz of 5 μm, 7 μm, 10 μm, 13 μm, 15 μm, 17 μm, 20 μm, 23 μm and 25 μm were prepared.

In this regard, the surface roughness Rz was measured in accordance with JIS (Japanese Industrial Standard) B0610. The surface roughness Rz was varied by using sandpapers with different grain sizes, or by varying sanding pressure.

The voltage applied to the collection roller 201 was varied among +100V, −100V, −250V, −300V, −500V, −700V, −1000V, −1140V, −1200V and −1300V.

The nip width between the photosensitive drum 101 and the collection roller 201 (preferably in a range from 0.5 to 3 mm) was set to 1.0 mm.

A roughness curve average length RSm (preferably in a range from 50 to 300 μm) was 100 μm.

A linear pressure between the photosensitive drum 101 and the collection roller 201 (preferably in a range from 13 to 56 gf/cm) was set to 30 gf/cm.

(7) The half-area solid image (FIG. 7A) was printed on 30000 pages continuously while replenishing the toner and the recording sheets 50 to the developing portion 100. Then, a whole-area halftone image (FIG. 7B) was printed on 10 pages, and printing quality was evaluated. The whole-area halftone image (FIG. 7B) was a halftone image portion 50b printed at the printing density 25% on the whole-area of the recording sheet 50 (i.e., area ratio was 100%) except the margin areas of 5 mm from four edges of the recording sheet 50.

(8) The image quality was evaluated as follows:

When the density unevenness of the printed image was not found, and the adhesion of the melamine resin particles (i.e., the external additives) to the surface of the charging roller 102 was not found by visual inspection, the evaluation result was “O” (i.e., excellent).

When the density unevenness of the printed image was not found, but the adhesion of the melamine resin particles to the surface of the charging roller 102 was found by visual inspection, the evaluation result was “Δ” (i.e., mediocre).

When the density unevenness of the printed image was found, the evaluation result was “X” (i.e., poor).

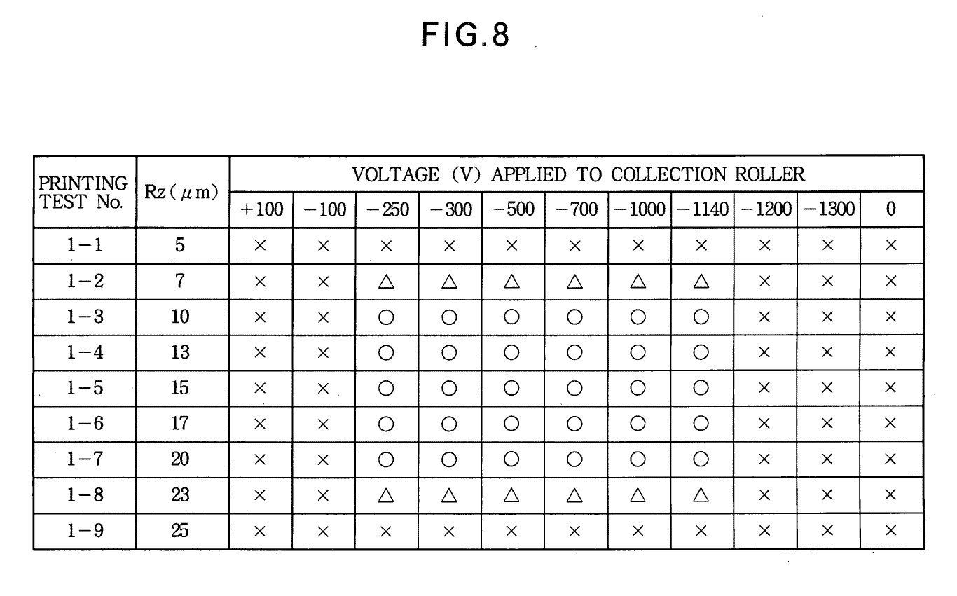

The evaluation results are shown in FIG. 8.

Referring to FIG. 8, description will be made of the printing tests 1-3 though 1-7 using the collection rollers 201 having the surface roughness of 10 μm, 13 μm, 15 μm, 17 μm and 20 μm.

In these printing tests 1-3 to 1-7, when the voltages applied to the collection roller 201 were −250V, −300V, −500V, −700V, −100V and −1140V, the evaluation results were “O”, and the adhesion of the melamine resin particles to the charging roller 102 was not found. Further, the adhesion of the melamine resin particles to the collection roller 201 was found.

Generally, the negatively-charged toner is transferred to the recording sheet 50 in the transfer process, and the residual toner (remaining on the photosensitive drum 101 after the transfer process) is removed from the photosensitive drum 101 by the cleaning blade 105. However, although the toner 110 has been negatively charged as a whole when the toner layer is formed on the developing roller 104, the positively-charged melamine resin particles (as external additives) still exist in the toner 110. Such positively-charged melamine resin particles tend to relatively strongly adhere to the photosensitive drum 101. Further, such melamine resin particles are smaller than the toner mother particles in diameter, and are less likely to be removed by the cleaning blade 105. For these reasons, the melamine resin particles tend to pass the cleaning blade 105.

When the voltages applied to the collection roller 201 were −250V, −300V, −500V, −700V, −1000V and −1140V, these voltages were lower than (and whose absolute values were larger than) the surface potentials VA1 (+40V), VA2 (−210V) and Vd (−80V) of the A1 part and A2 part of the photosensitive drum 101. Therefore, it is considered that the positively-charged melamine resin particles (having passed the cleaning blade 105) electrostatically moved from the photosensitive drum 101 toward the collection roller 201, and the adhesion of the melamine resin particles to the charging roller 102 was prevented. For this reason, the surface of the photosensitive drum 101 was uniformly charged by the charging roller 102, and density unevenness did not occur in the printed images.

In the printing tests 1-3 through 1-7, when the voltages applied to the charging roller 102 were −1200V and −1300V, density unevenness (smear) of the printed image was found, and the evaluation results were “X”. However, noticeable adhesion to the surface of the charging roller 102 was not found. Further, the adhesion of the melamine resin particles to the collection roller 201 was found.

In this case, the voltages applied to the collection roller 201 were −1200V and −1300V which were lower than (and whose absolute values were larger than) the surface potentials VA1 (+40V), VA2 (−210V) and Vd (−80V) of the A1 part and A2 part of the photosensitive drums 101. Therefore, it is considered that the positively-charged melamine resin particles moved from the photosensitive drum 101 toward the collection roller 201, and the adhesion of the melamine resin particles to the charging roller 102 was prevented.

However, since the voltages applied to the collection roller 201 were lower than (and whose absolute values were larger than) the voltages applied to the charging roller 102, it is considered that the surface potential of the photosensitive drum 101 was affected dominantly by the voltage of the collection roller 201. Therefore, it is considered that the surface potential of the photosensitive drum 101 became non-uniform due to the influence of the charge of the collection roller 201, and such non-uniform surface potential of the photosensitive drum 101 could not be uniformized by the charging roller 102, with the result that the density unevenness of the printed images occurred.

In the printing tests 1-3 through 1-7, when the voltages applied to the charging roller 102 were −100V, +100V and 0V, the density unevenness (smear) of the printed image was found, i.e., the evaluation results were “X”, and a large amount of the melamine resin particles adhering to the surface of the charging roller 102 was found.

In this case, the voltages applied to the collection roller 201 were −100V, +100V and 0V which were higher than (and whose absolute values were smaller than) the surface potential VA2 (−210V) of the A2 part of the photosensitive drum 101. Therefore, it is considered that the positively-charged melamine resin particles having passed the cleaning blade 105 did not electrostatically move from the photosensitive drum 101 to the collection roller 201, and adhered to the charging roller 102 applied with −1140V. Therefore, it is considered that, the photosensitive drum 101 was charged by the charging roller 102 with the melamine resin particles adhere thereto, and the density unevenness of the printed images occurred.

Next, referring to FIG. 8, description will be made of the evaluation result of the printing test 1-1 using the collection roller 201 having the surface roughness of 5 μm.

In this printing test 1-1, the density unevenness (smear) of the printed image occurred, i.e., the evaluation result was “X”, and a large amount of the melamine resin particles adhering to the charging roller 102 were found irrespective of voltages (including 0V) applied to the collection roller 201.

In this case, since the surface roughness of the collection roller 201 was low, it is considered that the collection roller 201 could not sufficiently hold the melamine resin particles at the surface thereof, even when the melamine resin particles once electrostatically moved to the collection roller 201. Therefore, it is considered that the melamine resin particles moved from the collection roller 201 to the photosensitive drum 101, and further moved to the charging roller 102. The surface of the photosensitive drum 101 was charged by the charging roller 102 with the melamine resin particles adhering thereto, and therefore the density unevenness of the printed image occurred.

Next, referring to FIG. 8, description will be made of the printing test 1-2 using the collection roller 201 having the surface roughness of 7 μm.

In this printing test 1-2, it is considered that, since the surface roughness of the collection roller 201 was not sufficient, the collection roller 201 could not sufficiently hold the melamine resin particles at the surface thereof. Therefore, part of the melamine resin particles moved from the collection roller 201 to the photosensitive drum 101 and further moved to the charging roller 102, even when the voltages applied to the collection roller 201 were −250V, −300V, −500V, —700V, −1000V and −1140V which were lower than (and whose absolute values were larger than) the surface potentials VA1 (+40V), VA2 (−210V) and Vd (−80V) of the A1 part and A2 part of the photosensitive drum 101. However, the adhesion of the melamine resin particles was at a relatively low level, and did not affect the density evenness, with the result that the evaluation result was “Δ”.

Next, referring to FIG. 8, description will be made of the printing test 1-9 using the collection roller 201 having the surface roughness of 25 μm.

In this printing test 1-9, the density unevenness (smear) of the printed image was found, i.e., the evaluation result was “X”, and a large amount of melamine resin particles adhering to the charging roller 102 were found irrespective of voltages (including 0V) applied to the collection roller 201.

In this case, since the surface roughness of the collection roller 201 was high (i.e., differences between convexes and concaves are large), it is considered that the electric field in the vicinity of the collection roller 201 became non-uniform, and the collection of the melamine resin particles by the collection roller 201 became non-uniform. Therefore, it is considered that the melamine resin particles remaining on the photosensitive drum 101 adhered to the charging roller 102, and the surface of the photosensitive drum 101 was charged by the charging roller 102 with the melamine resin particles adhering thereto, with the result that the density unevenness of the printed image occurred.

Next, referring to FIG. 8, description will be made of the printing test 1-8 using the collection roller 201 having the surface roughness of 23 μm.

In this case, since the surface roughness of the collection roller 201 was relatively high, it is considered that the collection of the melamine resin particles by the collection roller 201 became non-uniform. Therefore, part of the melamine resin particles adhered to the charging roller 102 even when the voltages applied to the collection roller 201 were −250V, −300V, −500V, −700V, −1000V and −1140V which were lower than (and whose absolute values were larger than) the surface potentials VA1 (+40V), VA2 (−210V) and Vd (−80V) of the A1 part and A2 part of the photosensitive drums 101. However, the adhesion of the melamine resin particles to the charging roller 102 was at a relatively low level, and did not affect the density evenness, with the result that the evaluation result was “Δ”.

Based on these experimental results and studies thereof, the following results were obtained.

The surface roughness Rz (μm) of the collection roller 201 is preferably in a range from 7 μm≦Rz≦23 μm, and more preferably in a range from 10 μm≦Rz≦20 μm.

When the voltage Vch applied to the charging roller 102 is negative, the voltage Vco (V) applied to the collection roller 201, the voltage Vch (V) applied to the charging roller 102, and the surface potential VA2 (V) of the photosensitive drum 101 (the non-exposed part) preferably satisfy the following relationship.

VA2>Vco≧Vch,

and more preferably satisfy:

VA2−40V≧Vco≧Vch.

Moreover, when the voltage Vch applied to the charging roller 102 is positive, the respective voltages and electric potentials are reversed, and therefore the voltages Vco and Vch and the surface potential VA2 preferably satisfy:

VA2<Vco≦Vch,

and more preferably satisfy:

VA2+40V≦Vco≦Vch.

In the above described configuration according to the first embodiment, the melamine resin particles are accumulated on the surface of the collection roller 201, and therefore it is preferable to provide a scraping unit for scraping off the melamine resin particles from the collection roller 201. Such a scraping unit can be composed of a sponge member of a felt member pressed against the collection roller 201.

Although the toner of cyan (C) was used in the above described printing tests, the same results were obtained when the toners of other colors were used.

As described above, according to the image forming unit of the first embodiment, the collection roller 201 is applied with the voltage having the same polarity as the polarity of the toner, i.e., the polarity of the toner as a whole (in this example, the polarity of the toner mother particles). Therefore, the external additives such as the melamine resin particles (which are charged to a polarity opposite to the polarity of the toner) can be collected by the collection roller 201. Thus, the adhesion of the external additives to the charging roller 102 can be prevented, and the collection roller 201 does not affect the surface potential of the photosensitive drum 101 charged by the charging roller 102. Accordingly, it is possible to prevent non-uniform charging of the photosensitive drum 101 due to the adhesion of the external additives to the charging roller 102 and due to the influence of the charge of the collection roller 201. As a result, the charging roller 102 can uniformly charge the surface of the photosensitive drum 101, so that the density unevenness of the printed image due to non-uniform charging can be prevented.

### Second Embodiment

In the second embodiment, in order to prevent a “drum filming” that tends to occur in low temperature and low humidity environment, the rotating direction and the circumferential speed of the collection roller 201 are further defined in the image forming apparatus 10 and the image forming unit (FIGS. 1-6) having been described in the first embodiment.

In the low temperature and low humidity environment, a rubber hardness of the cleaning blade 105 increases, and therefore the cleaning blade 105 is strongly pressed against the surface of the photosensitive drum 101. Due to increase in frictional force between the toner and the photosensitive drum 101, the toner may be fusion-bonded to the photosensitive drum 101, i.e., a drum filming may occur. Although the collection roller 201 of the first embodiment is applied with a predetermined voltage so as to collect the external additives (such as the melamine resin particles) charged to a Polarity opposite to the toner, the collection roller 201 of the second embodiment scrapes off the toner from the photosensitive drum 101 at a sliding contact portion therebetween so as to also prevent the drum filming.

In order to examine the effect of preventing the drum filming by the collection roller 201 that scrapes off the toner from the photosensitive drum 101, a printing test 2 was performed while varying the rotating direction and the circumferential speed of the collection roller 201.

The printing test 2 was performed under the conditions (1) to (8) described in the first embodiments with the following changes:

Regarding the condition (2), the printing was performed under low temperature (10° C.) and low humidity environment (20%).

Regarding the condition (6), the collection roller 201 had the surface roughness Rz of 13 μm and the voltage applied to the collection roller 201 was −300V.

Regarding the condition (3), the printing speed (equal to the circumferential speed of the photosensitive drum 101, and the sheet feeding speed) was set to 230 mm/s.

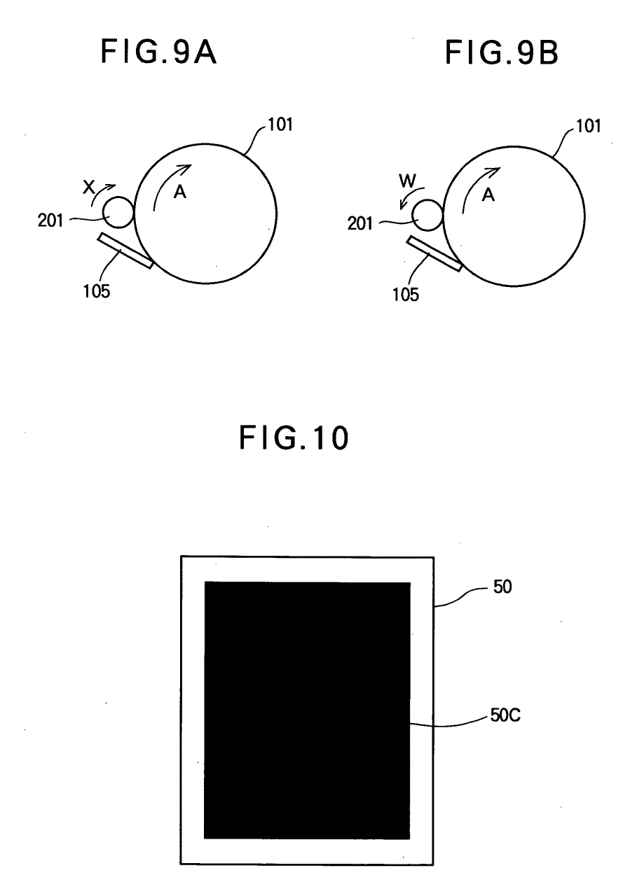

Further, the rotating direction of the collection roller 201 was set in two ways: in the same direction as the photosensitive drum 101 as shown by an arrow X in FIG. 9A and in the opposite direction to the photosensitive drum 101 as shown by an arrow W in FIG. 9B. The circumferential speed of the collection roller 201 was set in various ways for each of the rotating directions.

Regarding the condition (5), the half-area solid image shown in FIG. 7A was continuously printed on 30000 pages, and then a whole-area solid image shown in FIG. 10 was printed on 10 pages. In this regard, the solid image of FIG. 10 was an image formed at the printing density of 100% and at the area ratio of 100% (i.e., printed on the whole-area of the recording sheet 50 except the margin areas of 5 mm from four edges).

Regarding the condition (8), the evaluation was performed as follows:

When the fusion-bonding of the toner was found on the surface of the photosensitive drum 101, and when white spots (due to the fusion-bonding of the toner) were found on the printed image, it was determined that the drum filming occurred.

When no fusion-bonding of the toner was found on the surface of the photosensitive drum 101, and when no white spot (due to the fusion-bonding of the toner) was found on the printed image, it was determined that the drum filming did not occur.

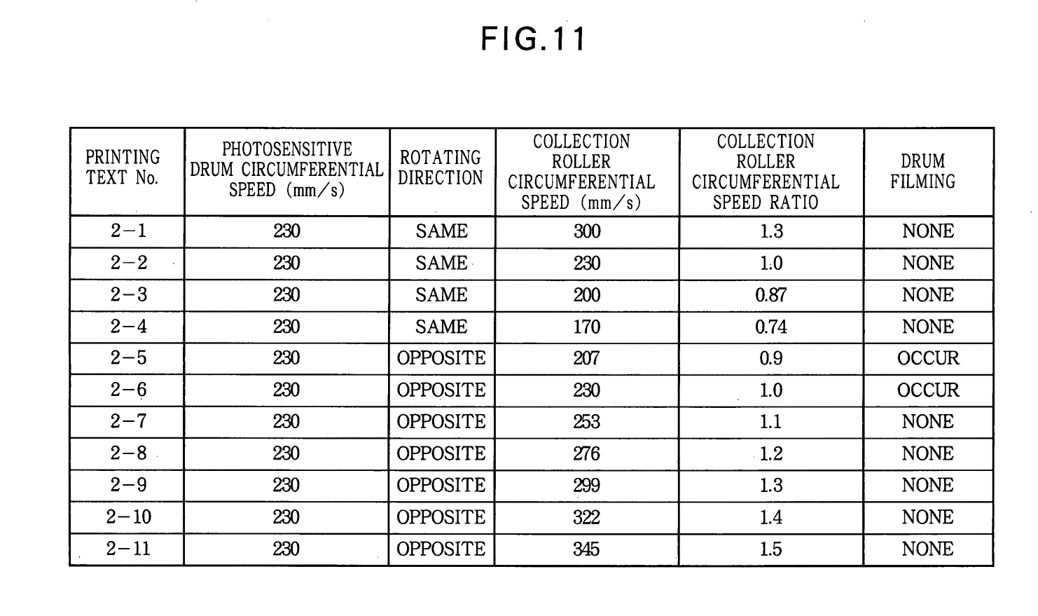

The evaluation results are shown in FIG. 11.

Referring to FIG. 11, the printing tests 2-1 to 2-4 will be described. In the printing tests 2-1 to 2-4, the rotating direction of the collection roller 201 was the same as the rotating direction of the photosensitive drum 101 as shown by the arrow X in FIG. 9A, and the circumferential speed of the collection roller 201 was set to 300 mm/s, 230 mm/s, 200 mm/s and 170 mm/s respectively corresponding to 1.3, 1.0, 0.87 and 0.78 with respect to the circumferential speed of the photosensitive drum 101 (i.e., 230 mm/s).

In these printing tests 2-1 to 2-4, no drum filming occurred. This considered to be because, at a contact portion between the collection roller 201 and the photosensitive drum 101, the surfaces of the collection roller 201 and the photosensitive drum 101 move in the directions opposite to each other, and therefore the fusion-bonded toner was effectively scraped off from the surface of the photosensitive drum 101.

Referring to FIG. 11, the printing tests 2-7 to 2-11 will be described. In the printing tests 2-7 to 2-11, the rotating direction of the collection roller 201 was opposite to the rotating direction of the photosensitive drum 101 as shown by the arrow W in FIG. 9B, and the circumferential speed of the collection roller 201 was set to 253 mm/s, 276 mm/s, 299 mm/s, 322 mm/s and 345 mm/s respectively corresponding to 1.1, 1.2, 1.3, 1.4 and 1.5 with respect to the circumferential speed of the photosensitive drum 101 (i.e., 230 mm/s).

In these printing tests 2-7 to 2-11, no drum filming occurred. This is considered to be because the fusion-bonded toner was scraped off from the surface of the photosensitive drum 101 by the sliding contact between the collection roller 201 and the photosensitive drum 101.

Referring to FIG. 11, the printing tests 2-5 and 2-6 will be described. In the printing tests 2-5 and 2-6, the rotating direction of the collection roller 201 was opposite to the rotating direction of the photosensitive drum 101 as shown by the arrow W in FIG. 9B, and the circumferential speed of the collection roller 201 was set to 207 mm/s and 230 mm/s respectively corresponding to 0.9 and 1.0 with respect to the circumferential speed of the photosensitive drum 101 (i.e., 230 mm/s).

In these printing tests 2-5 and 2-6, the drum filming occurred. This is considered to be because, at the contact portion between the collection roller 201 and the photosensitive drum 101, a difference between the circumferential speeds of the collection roller 201 and the photosensitive drum 101 was relatively small (in particular, zero in the printing test 2-6), and therefore the fusion-bonded toner was not sufficiently scraped off from the surface of the photosensitive drum 101.

Based on these experimental results and studies, the following results were obtained.

In order to prevent the drum filming, the rotating direction of the collection roller 201 is preferably in the same direction as the photosensitive drum 101. In other words, at the contact portion between the collection roller 201 and the photosensitive drum 101, the surfaces of the collection roller 201 and the photosensitive drum 101 preferably move in directions opposite to each other. Further, if the rotating direction of the collection roller 201 is opposite to the direction of the photosensitive drum 101, the circumferential speed of the collection roller 201 is preferably at least 1.1 times faster than that of the photosensitive drum 101 particularly.

The above described printing test 2 was performed under the conditions that the surface roughness Rz of the collection roller 201 is 13 μm and the voltage Vco applied to the collection roller 201 is −300V. In this regard, the same results were obtained when further printing tests were performed under the conditions that the surface roughness Rz of the collection roller 201 is in a range from 7 μm to 23 μm and the voltage Vco applied to the collection roller 201 is in a range from −250V to −1140V.

According to the second embodiment of the present invention, the drum filming can be prevented by suitably setting the rotating direction and the circumferential speed of the collection roller 201 even under the low temperature and low humidity environment.

In the first and second embodiments, a direct transfer system in which the toner image is transferred to the recording sheet 50 (i.e., a medium) has been described. However, it is also possible to employ an intermediate transfer system in which the toner image is once transferred to an intermediate transfer belt.

Further, in the first and second embodiment, the image forming apparatus has been described as the printer. However, the present invention is applicable to a facsimile machine, a copier, a MFP (i.e., a multifunction peripheral) or the like having a developing portion with an image bearing body (i.e., a photosensitive drum).

While the preferred embodiments of the present invention have been illustrated in detail, it should be apparent that modifications and improvements may be made to the invention without departing from the spirit and scope of the invention as described in the following claims.

What is claimed is:—

1. An image forming unit comprising:
an image bearing body on which a latent image is formed;
a charging member that electrically charges said image bearing body;
a developer bearing body that develops said latent image on said image bearing body using a developer so as to form a developer image;
a transfer portion that transfers said developer image to a medium;
a cleaning member that removes an adhering matter that adheres to part of said image bearing body after said part of said image bearing body passes said transfer portion;
a collection roller provided so as to form a contact portion between said collection roller and said image bearing body, said collection roller being located between said cleaning member and said charging member, and
a collection roller power source that applies a voltage to said collection roller, said voltage having the same polarity as a polarity of said developer.

2. The image forming unit according to claim 1, wherein said developer includes a toner containing toner mother particles formed of at least binder resin and external additives added to said toner mother particles,
wherein at least part of said external additives are charged to a polarity opposite to a polarity of said toner as a whole.

3. The image forming unit according to claim 2, wherein said toner is negatively chargeable as a whole, and said at least part of said external additives are positively chargeable.

4. The image forming unit according to claim 2, wherein said part of said external additives include melamine resin particles.

5. The image forming unit according to claim 2, wherein said voltage applied to said collection roller by said collection roller power source has the same voltage as said polarity of said toner as a whole.

6. The image forming unit according to claim 2, wherein said developer is a single component developer containing said toner.

7. The image forming unit according to claim 2, wherein said toner is a non-magnetic toner.

8. The image forming unit according to claim 1, wherein said developer includes a toner containing toner mother particles formed of at least binder resin and external additives added to said toner mother particles,
wherein at least part of said external additives are charged to a polarity opposite to a polarity of said mother particles.

9. The image forming unit according to claim 8, wherein said voltage applied to said collection roller by said collection roller power source has the same voltage as said polarity of said toner mother particles.

10. The image forming unit according to claim 1, wherein a voltage Vco applied to said collection roller, a voltage Vch applied to said charging member and a maximum surface potential VA2 of said image bearing body after said developer image is transferred to said medium satisfy:
VA2>Vco≧Vch
in the case where said voltage Vch is negative, and
VA2<Vco≦Vch
in the case where said voltage Vch is positive.

11. The image forming unit according to claim 10, wherein said voltage Vco applied to said collection roller, said voltage Vch applied to said charging member and said maximum surface potential VA2 satisfy:
VA2−40V≧Vco≧Vch
in the case where said voltage Vch is negative, and
VA2+40V≦Vco≦Vch
in the case where said voltage Vch is positive.

12. The image forming unit according to claim 1, wherein said collection roller has a surface roughness Rz (μm) in the following range: 7 μm≦Rz≦23 μm.

13. The image forming unit according to claim 12, wherein said collection roller has a surface roughness Rz (μm) in the following range: 10 μm≦Rz≦20 μm.

14. The image forming unit according to claim 1, wherein said collection roller rotates so as to slidably contact said image forming body at said contact portion.

15. The image forming unit according to claim 14, wherein said image bearing body is in the form of a drum, and rotates in a predetermined direction, and
wherein said collection roller also rotates in said predetermined direction.

16. The image forming unit according to claim 14, wherein said image bearing body and said collection roller rotate in the same direction as each other.

17. The image forming unit according to claim 14, wherein said image bearing body and said collection roller rotate in directions opposite to each other.

18. The image forming unit according to claim 17, wherein said collection roller rotates at a circumferential speed faster than a circumferential speed of said image bearing body.

19. The image forming unit according to claim 18, wherein said collection roller rotates at a circumferential speed at least 1.1 times faster than a circumferential speed of said image bearing body.

20. An image forming apparatus comprising:
a medium feeding portion;
said image forming unit according to claim 1;
a fixing portion, and
a medium ejecting portion.
